(19) United States
(12) Patent Application Publication
(10) Pub. No.: US 2025/0048328 A1
(43) Pub. Date: Feb. 6, 2025

(54) SIDELINK SLOT DESIGN FOR SIDELINK POSITIONING REFERENCE SIGNAL TRANSMISSION AND RECEPTION

(71) Applicant: Nokia Technologies OY, Espoo (FI)

(72) Inventors: Nuno Manuel KIILERICH PRATAS, Aalborg (DK); Prajwal KESHAVAMURTHY, Munich (DE); Oana-Elena BARBU, Aalborg (DK); Benny VEJLGAARD, Aalborg (DK); Johannes HARREBEK, Aalborg (DK); Jan Torst HVIID, Aalborg (DK)

(21) Appl. No.: 18/717,366

(22) PCT Filed: Dec. 19, 2022
(86) PCT No.: PCT/IB2022/062471

§ 371 Date: Jun. 6, 2024

Related U.S. Application Data
(60) Provisional application No. 63/296,303, filed on Jan. 4, 2022.

(51) Int. Cl. H04W 64/00; H04W 72/25

(52) U.S. Cl. CPC H04W 64/003; H04W 72/25

(57) ABSTRACT

An apparatus, comprising: at least one processor; and at least one memory comprising computer program instructions, wherein the at least one memory and the computer program instructions are configured to, with the at least one processor, cause the apparatus at least to perform: sending (1a, 1b.i, 1.b.ii), to an anchor user equipment, a sidelink positioning request in a channel, wherein the sidelink positioning request comprises a first pay load: receiving (2. a, 2.b.i, 2.b.ii, 3), from the anchor user equipment, a sidelink positioning response, wherein the sidelink positioning response is sent according to the pay load of the sidelink positioning request, wherein the sidelink positioning response comprises a second pay load; and determining (4) a position of the apparatus based on the second payload

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing sidelink slots and suitable configuration thereof for sidelink positioning reference signal transmission and reception.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform sending, to an anchor user equipment, a sidelink positioning request in a channel. The sidelink positioning request can include a first payload. The at least one memory and computer program code can also be configured, with the at least one processor, to cause the apparatus at least to perform receiving, from the anchor user equipment, a sidelink positioning response. The sidelink positioning response can be sent according to the payload of the sidelink positioning request. The sidelink positioning response can include a second payload. The at least one memory and computer program code can further be configured, with the at least one processor, to cause the apparatus at least to perform determining a position of the apparatus based on the second payload.

An embodiment may be directed to an apparatus. The apparatus can include at least one processor and at least one memory comprising computer program code. The at least one memory and computer program code can be configured, with the at least one processor, to cause the apparatus at least to perform receiving, from a target user equipment, a sidelink positioning request on a channel. The sidelink positioning request can include a first payload. The at least one memory and computer program code can also be configured, with the at least one processor, to cause the apparatus at least to perform sending, to the target user equipment, a sidelink positioning response. The sidelink positioning response can be sent according to the payload of the sidelink positioning request. The sidelink positioning response can include a second payload. The second payload can be configured to enable the target user equipment to determine a position of the target user equipment.

An embodiment may be directed to a method. The method may include sending, from a target user equipment to an anchor user equipment, a sidelink positioning request in a channel. The sidelink positioning request can include a first payload. The method may also include receiving, from the anchor user equipment, a sidelink positioning response. The sidelink positioning response can be sent according to the payload of the sidelink positioning request. The sidelink positioning response can include a second payload. The method can further include determining a position of the target user equipment based on the second payload.

An embodiment may be directed to a method. The method may include receiving, from a target user equipment, a sidelink positioning request on a channel. The sidelink positioning request can include a first payload. The method may also include sending, to the target user equipment, a sidelink positioning response. The sidelink positioning response can be sent according to the payload of the sidelink positioning request. The sidelink positioning response can include a second payload. The second payload can be configured to enable the target user equipment to determine a position of the target user equipment.

An embodiment may be directed to an apparatus. The apparatus may include means for sending, to an anchor user equipment, a sidelink positioning request in a channel. The sidelink positioning request can include a first payload. The apparatus may also include means for receiving, from the anchor user equipment, a sidelink positioning response. The sidelink positioning response can be sent according to the payload of the sidelink positioning request. The sidelink positioning response can include a second payload. The apparatus can further include means for determining a position of the apparatus based on the second payload.

An embodiment may be directed to an apparatus. The apparatus may include means for receiving, from a target user equipment, a sidelink positioning request on a channel. The sidelink positioning request can include a first payload. The apparatus may also include means for sending, to the target user equipment, a sidelink positioning response. The sidelink positioning response can be sent according to the payload of the sidelink positioning request. The sidelink positioning response can include a second payload. The second payload can be configured to enable the target user equipment to determine a position of the target user equipment.

### BRIEF DESCRIPTION OF THE DRAWINGS

For proper understanding of example embodiments, reference should be made to the accompanying drawings, wherein:

FIG. 1 illustrates sidelink positioning scenarios for vehicle to everything and public safety use cases;

FIG. 2A illustrates new radio sidelink resource allocation mode 1;

FIG. 2B illustrates new radio sidelink resource allocation mode 2;

FIG. 3A illustrates a sidelink slot format for a slot with physical sidelink control channel and physical sidelink shared channel;

FIG. 3B illustrates a sidelink slot format for a slot with physical sidelink control channel, physical sidelink shared channel, and physical sidelink feedback channel.

FIG. 4 illustrates PSSCH DMRS configurations based on the number of used symbols and duration of the PSCCH, as described in 3GPP TS 38.211.

FIG. 5A illustrates positioning metadata contained within the PSSCH part of the slot, while the S-PRS transmission is contained within the remaining symbols denoted as PSPCH, according to certain embodiments;

FIG. 5B illustrates a slot format, where the cross slot indication of the S-PRS is included in the payload, according to certain embodiments;

FIG. 5C illustrates a slot format where a single symbol is reserved for the PSPCH;

FIG. 5D illustrates a slot format where multiple symbols are reserved for the PSPCH, according to certain embodiments;

FIG. 6 illustrates examples of use cases of the slot format for 2-step positioning or round trip time, according to certain embodiments;

FIG. 7 illustrates an alternative application of the cross slot positioning indication, according to certain embodiments;

FIG. 8 illustrates an example flow diagram of a method, according to an embodiment;

FIG. 9 illustrates an example flow diagram of a method, according to an embodiment; and

FIG. 10 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing sidelink slots and suitable configuration thereof for sidelink positioning reference signal transmission and reception, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Positioning in the third generation partnership project (3GPP) can refer to the process of determining a current position of a user equipment (UE). New Radio (NR) may have native positioning support. As a result, NR release 16 (Rel-16) may provide positioning approaches based on downlink (DL) time difference of arrival (TDOA) (DL-TDOA), uplink (UL) TDOA (UL-TDOA), DL angle of departure (DL-AoD), UL angle of arrival (UL-AoA), and multi-cell round trip time (Multi-RTT).

It may be valuable to enable radio access technology (RAT) dependent and RAT independent NR positioning techniques. The RAT dependent positioning techniques may be for both frequency range 1 (FR1) and frequency range 2 (FR2).

In the DL there is a positioning reference signal (PRS) and in the UL there is a sounding reference signal (SRS) for positioning (SRS-P). UE-based positioning for DL techniques (e.g., DL-TDOA) can include the UE makes both the positioning measurements and the location estimate locally. In UE-based mode the location of the gNBs is sent to the UE for use in the location estimation process.

It may be valuable to specify methods, measurements, signaling, and procedures for improving positioning accuracy of the above-described positioning methods by mitigating UE reception (Rx)/transmission (Tx) and/or next generation Node B (gNB) Rx/Tx timing delays, including DL, UL and DL+UL positioning methods, as well as UE-based and UE-assisted positioning solutions.

It may also be valuable to specify the procedure, measurements, reporting, and signaling for improving the accuracy of UL AoA for network-based positioning solutions and DL-AoD for UE-based and network-based (including UE-assisted) positioning solutions.

It may further be valuable to specify methods, measurements, signaling and procedures to support positioning for UEs in radio resource control (RRC) inactive (RRC_INACTIVE) state, for UE-based and UE-assisted positioning solutions, including DL NR positioning methods and RAT-independent positioning methods. For example, it may be valuable to consider support of UE positioning measurements for UEs in RRC_INACTIVE state. Moreover, it may be valuable to consider reporting of positioning measurement or location estimate performed in RRC_INACTIVE when the UE is in RRC_INACTIVE state. Additionally, it may be valuable to consider UL and DL+UL NR positioning methods and support of gNB positioning measurements for UEs in RRC_INACTIVE state.

One example of positioning is sidelink positioning. Sidelink positioning/ranging together with reduced capability (RedCap) positioning, may benefit from improved accuracy, integrity, and power efficiency.

Various aspects of positioning can include ranging, low-power positioning, accuracy enhancements to the centimeter (cm) level, RAT-dependent positioning integrity, and latency reduction.

For ranging, a sidelink-based technique may be applied. Low-power positioning may primarily focus on RedCap devices but may also be applicable to other devices. Support for positioning in RRC idle state (RRC_IDLE) and RRC_INACTIVE may be relevant to low-power positioning.

Techniques for accuracy enhancement in general, apart from sidelink assistance, can include terrestrial carrier-phase positioning, PRS/sounding reference signal (SRS) bandwidth aggregation, and the use of wide bandwidths in unlicensed spectrum, such as at 60 GHz, which may also imply the ability to transmit PRS in unlicensed spectrum, which can also be seen as relevant for sidelink positioning.

It may also be valuable to consider support of mobile terminated (MT)-triggered small data transmission (SDT), at least for network-initiated positioning use cases.

Sidelink positioning can support at least three use cases: sidelink absolute, sidelink relative, and sidelink assisted. Sidelink absolute can provide position based on devices of known location and can provide an absolute location known, for example in longitude (long.) and latitude (lat.). Sidelink relative can provide a distance and angle calculated by target with a relative location known. Sidelink assisted can provide a position calculated by location services (LCS), which may be an absolute location known in terms of latitude and longitude.

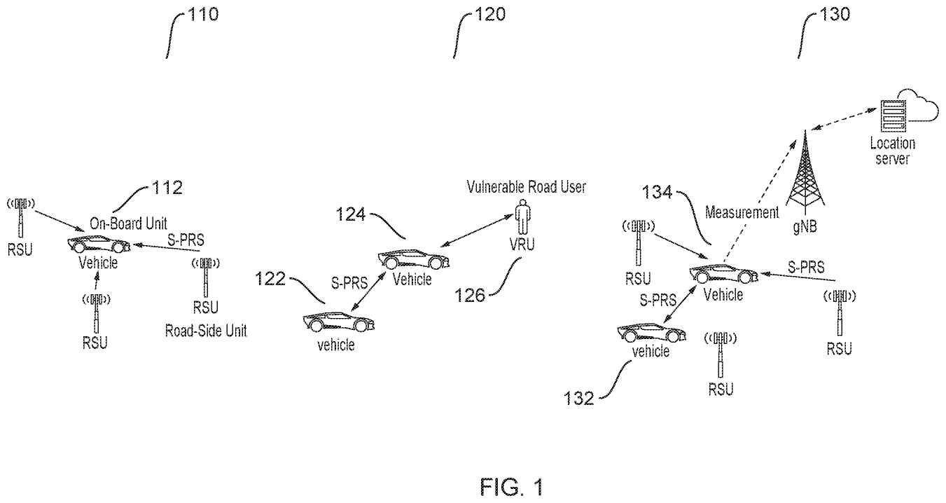

FIG. 1 illustrates example sidelink positioning scenarios for vehicle to everything (V2x) and public safety use cases. As shown in FIG. 1 sidelink absolute 110 may determine position of a first vehicle 112 by having an on-board unit communicate with a plurality of radio-side units (RSUs). Sidelink relative 120 may determine a distance and angle calculated with respect to a target, so that a second vehicle 122 can be aware of the position of a third vehicle 124 and a vulnerable road user (VRU), such as pedestrian 126. Sidelink assisted 130 may allow a SL-equipped fourth vehicle 132 to take advantage of positioning obtained by a fifth vehicle 134 using location services. Sidelink absolute 110 and sidelink relative 120 may be performed in an out of coverage or sidelink-only mode in coverage, while sidelink assisted 130 may be useful in an in coverage or partial coverage scenario.

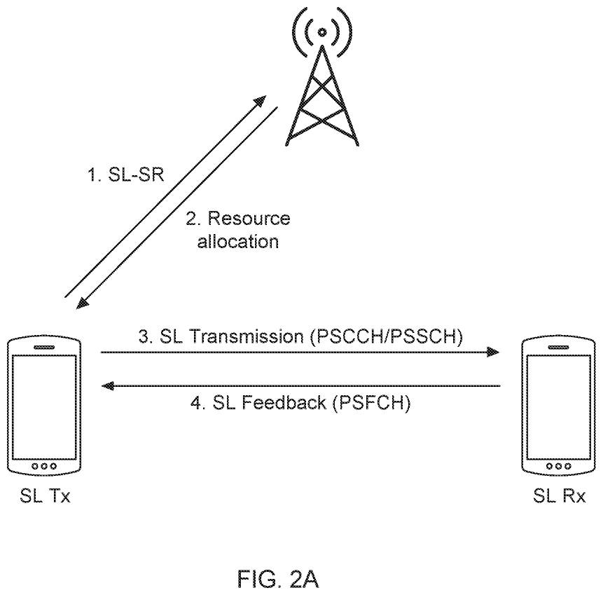

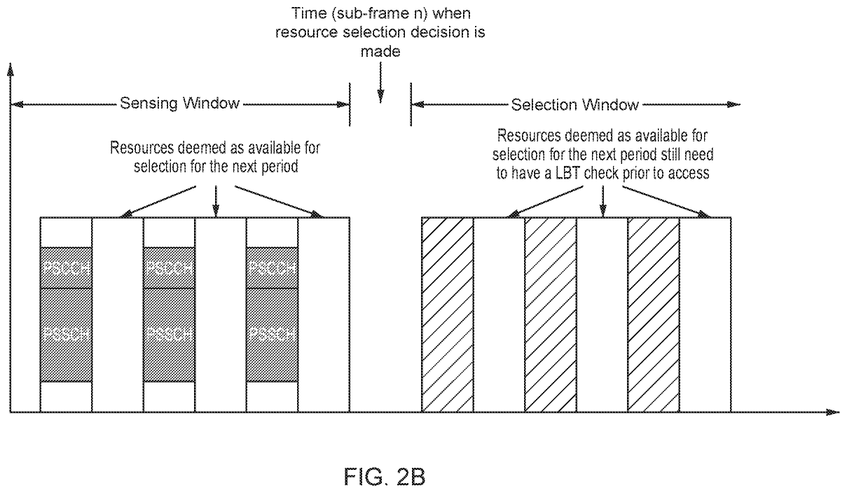

NR SL may facilitate a UE to communicate with other nearby UE(s) via direct/SL communication. Two resource allocation modes have been specified, and a SL transmitter (Tx) UE can be configured with one of the two resource allocation modes to perform the UE's NR SL transmissions. These modes are denoted as NR SL mode 1 and NR SL mode 2, for ease of reference and not by indication of any kind of priority or preference. FIG. 2A illustrates new radio sidelink resource allocation mode 1, while FIG. 2B illustrates new radio sidelink resource allocation mode 2.

In mode 1, a sidelink transmission resource can be assigned by the network (NW) to the SL Tx UE in response to a scheduling request (SR), while a SL Tx UE in mode 2 can autonomously select the UE's own SL transmission resources.

In mode 1, where the gNB is responsible for the SL resource allocation, the configuration and operation is similar to the one over the Uu interface, as illustrated in FIG. 1. The medium access control (MAC) level details of this procedure are given in third generation partnership project (3GPP) technical specification (TS) 38.321, section 5.8.3. Communication between the SL Tx UE and the SL Rx UE can occur with SL transmission and feedback as shown in FIG. 2A.

In mode 2, the SL UEs can autonomously perform the resource selection with the aid of a sensing procedure. More specifically, a SL Tx UE in NR SL mode 2 can first perform a sensing procedure over the configured SL transmission resource pool(s), in order to obtain the knowledge of the reserved resource(s) by other nearby SL Tx UE(s). Based on the knowledge obtained from sensing during a sensing window, the SL Tx UE may select resource(s) from the available SL resources, accordingly, to be used during the selection window. In order for a SL UE to perform sensing and obtain the necessary information to receive a SL transmission, the SL UE may need to decode the sidelink control information (SCI). In release 16, the SCI associated with a data transmission includes a 1st stage SCI and 2nd stage SCI, and their contents are standardized in 3GPP TS 38.212.

SL transmissions can be organized into frames identified by the direct frame number (DFN). The DFN may enable a UE to synchronize the UE's radio frame transmissions according to an SL timing reference. UEs can perform SL synchronization to have the same SL timing reference for SL communication among nearby UEs by synchronizing with a reference. There may be at least four sources for synchronization reference: global navigation satellite system (GNSS) or global positioning system (GPS), NR Cell (for example, gNB), evolved universal mobile telecommunication system (UMTS) terrestrial radio access network (EUTRAN) Cell (for example, an eNB), a synchronization reference (SyncRef) UE, or the UE's own internal clock. Here, a SyncRef UE can be a UE acting as synchronization reference source that either extends the synchronization coverage of another synchronization source (for example, GNSS, gNB/eNB or another SyncRef UE) or uses the SnycRef's own internal clock as the synchronization reference.

Sidelink control information can follow a 2-stage SCI structure. The 2-stage SCI structure may support the size difference between the SCIs for various V2x SL service types, such as broadcast, groupcast, and unicast.

The 1st stage SCI, SCI format 1-A, carried by physical sidelink control channel (PSCCH), can contain information to enable sensing operations and information needed to determine resource allocation of the physical sidelink shared channel (PSSCH) and to decode 2nd stage SCI.

The contents of the SCI 1st stage are described in 3GPP TS 38.212, section 8.3.1.1. These contents may include a frequency resource assignment that has

$$⌈ {log}_{2} ( \frac{{N}_{subCha𝔫𝔫el}^{SL} ( {N}_{subChannel}^{SL} + 1 )}{2} ) ⌉$$

bits when the value of the higher layer parameter sl-MaxNumPerReserve is configured to 2. Otherwise the frequency resource assignment can be

$$⌈ {log}_{2} ( \frac{{N}_{subCha𝔫𝔫el}^{SL} ( {N}_{subCha𝔫𝔫el}^{SL} + 1 ) ( 2 {N}_{subCha𝔫𝔫el}^{SL} + 1 )}{6} ) ⌉$$

bits when the value of the higher layer parameter sl-MaxNumPerReserve is configured to 3, as defined in 3GPP TS 38.214, section 8.1.2.2. The contents can also include a time resource assignment that can have 5 bits when the value of the higher layer parameter sl-MaxNumPerReserve is configured to 2, otherwise 9 bits when the value of the higher layer parameter sl-MaxNumPerReserve is configured to 3, as defined in 3GPP TS 38. 214, section 8.1.2.1.

The 2nd stage SCI, SCI format 2-A and 2-B, carried by PSSCH (multiplexed with SL-SCH) can contain source and destination identities, information to identify and decode the associated SL-SCH transport block (TB), control of hybrid automatic repeat request (HARQ) feedback in unicast/groupcast, and a trigger for channel state information (CSI) feedback in unicast.

An example of the contents of the SCI 2nd stage can be as provided in Table 1:

TABLE 1
2nd stage SCI formats

| SCI Format 2-A | SCI Format 2-B |
|---|---|
| HARQ process number - 4 | HARQ process number - 4 |
| bits. | bits. |
| New data indicator - 1 bit. | New data indicator - 1 bit. |
| Redundancy version - 2 bits as | Redundancy version - 2 bits |
| defined in Table 7.3.1.1.1-2. | as defined in Table 7.3.1.1.1- |
| Source ID - 8 bits as defined | 2. |
| in clause 8.1 of 3GPP TS | Source ID - 8 bits as defined |
| 38.214. | in clause 8.1 of 3GPP TS |
| Destination ID - 16 bits as | 38.214. |
| defined in clause 8.1 of 3GPP | Destination ID - 16 bits as |
| TS 38.214. | defined in clause 8.1 of |
| HARQ feedback | 3GPP TS 38.214. |
| enabled/disabled indicator - 1 | HARQ feedback |
| bit as defined in clause 16.3 of | enabled/disabled indicator - |
| 3GPP TS 38.213. | 1 bit as defined in clause |
| Cast type indicator - 2 bits as | 16.3 of 3GPP TS 38.213. |
| defined in Table 8.4.1.1-1 and | Zone ID - 12 bits as defined |
| in clause 8.1 of 3GPP TS | in clause 5.8.11 of 3GPP TS |
| 38.214. | 38.331. |
| CSI request - 1 bit as defined | Communication range |
| in clause 8.2.1 of 3GPP TS | requirement - 4 bits determined |
| 38.214 and in clause 8.1 of | by higher layer parameter sl- |
| 3GPP TS 38.214. | ZoneConfigMCR-Index. |

The configuration of the resources in the sidelink resource pool can define the minimum information required for a Rx UE to be able to decode a transmission, which can include the number of sub-channels, the number of physical resource blocks (PRBs) per sub-channels, the number of symbols in the PSCCH, which slots have a physical feedback sidelink channel (PSFCH) and other configuration aspects.

The details of the actual sidelink transmission, for example the payload, can be provided in the PSCCH (SCI 1st stage) for each individual transmission. The details can include the time and frequency resources, the demodulation reference signal (DMRS) configuration of the PSSCH, the modulation and coding scheme (MCS), and PSFCH, among others.

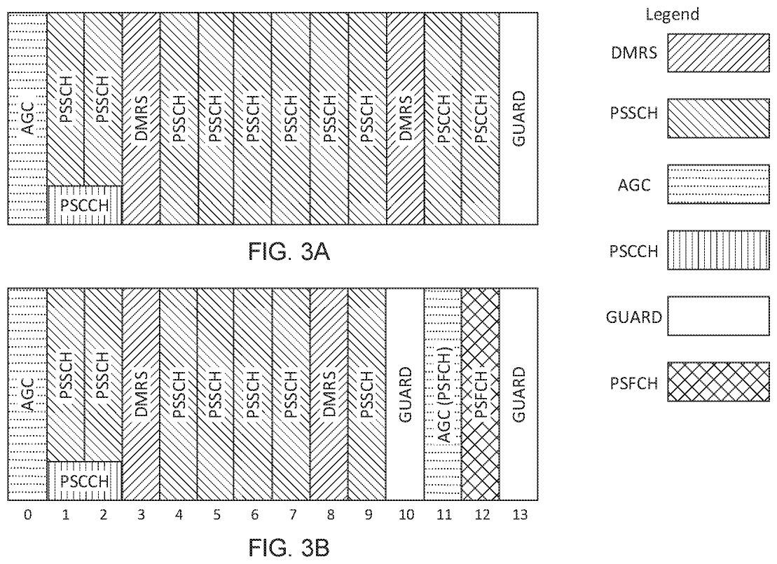

FIG. 3A illustrates an example of a sidelink slot format for a slot with physical sidelink control channel and physical sidelink shared channel. By contrast, FIG. 3B illustrates an example of a sidelink slot format for a slot with physical sidelink control channel, physical sidelink shared channel, and physical sidelink feedback channel.

FIGS. 3A and 3B provide examples of SL slot structures, with a difference between them being that in FIG. 3B the last symbols are used for PSFCH.

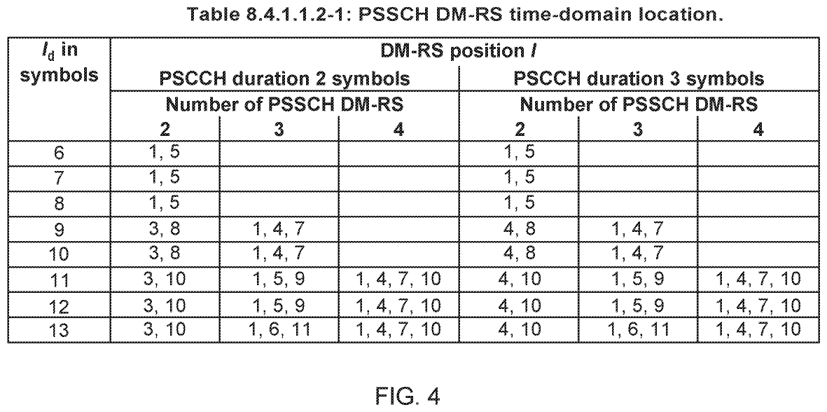

The configuration of the PSCCH (e.g. DMRS, MCS, number of symbols used) is part of the resource pool configuration. Furthermore, the indication of which slots have PSFCH symbols is also part of the resource pool configuration. However, the configuration of the PSSCH (e.g. the number of symbols used, the DMRS pattern and the MCS) is provided by the 1st stage SCI which is the payload sent within the PSCCH and follows the configuration depicted in the example of FIG. 4.

FIG. 4 illustrates example PSSCH DMRS configurations based on the number of used symbols and duration of the PSCCH, as described in 3GPP TS 38.211.

The introduction of ranging/positioning capabilities in SL may require the introduction of the capability to transmit and receive sidelink positioning reference signals (S-PRSs) into the sidelink system design. These signals may be implemented as constant amplitude zero autocorrelation (CAZAC)-like sequences to make sure that the channel delays can be extracted even in a non-synchronized scenario. Another approach would be to reuse the existing DMRS, either in PSCCH or PSSCH. Such reuse may require a strict synchronization in SL, which may not always be guaranteed, because different SL UEs can have different synchronization sources, especially when out of network coverage.

The introduction of S-PRS into the sidelink system design, more precisely its channelization including the assignment of resources into which sidelink should be deployed, may be done in a way that avoids backward compatibility issues, in certain embodiments.

For example, in certain embodiments the design may at least ensure that the transmission of an S-PRS can be done in a resource pool where other non-S-PRS transmitting SL UEs perform their transmissions/receptions. One benefit or advantage of this design approach is that it may minimize the need to fragment the resources across different resource pools and in doing so minimize the resource underutilization. Accordingly, certain embodiments may provide efficient and backwards compatible introduction of S-PRS into the sidelink system design.

In certain embodiments, the transmission of the S-PRS may be integrated within the defined SL slot format structure, so that the transmission of the S-PRS can coexist with other non-positioning related SL transmissions within the same resource pool. Additionally, in connection with the S-PRS transmission, there can also be transmitted positioning metadata, such as the S-PRS transmitting device known position, Rx-Tx time for RTT, or the like. The combination of the S-PRS and positioning metadata can reduce the need for additional signaling exchanges between a target UE and an anchor UE. In certain embodiments, both pieces of information can be sent up front, namely at an early point in the process. The target UE can be the UE that requires positioning/ranging. The anchor UE can be the UE that serves as positioning anchor or ranging target.

The following discussion provides examples of how such information can be combined to enable positioning. In the following, for ease of illustration, it is assumed that a new sidelink channel is introduced for the transmission of the S-PRS denoted as physical sidelink positioning channel (PSPCH).

For the integration of S-PRS and positioning metadata within an SL slot, certain embodiments may provide two complementary implementations which are denoted as self-contained positioning slot and cross slot positioning indication, respectively.

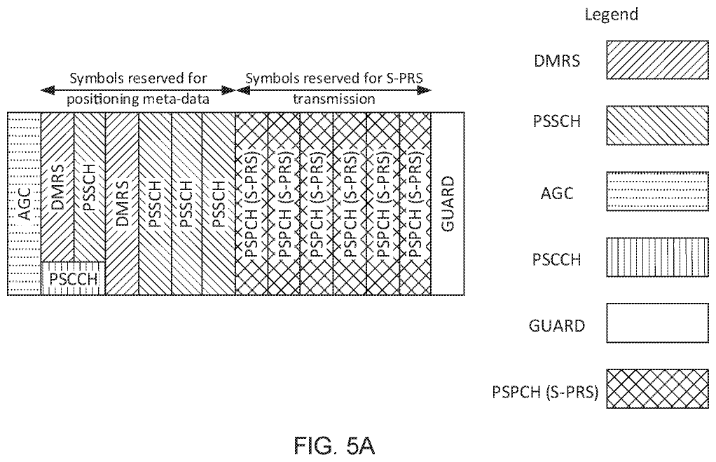

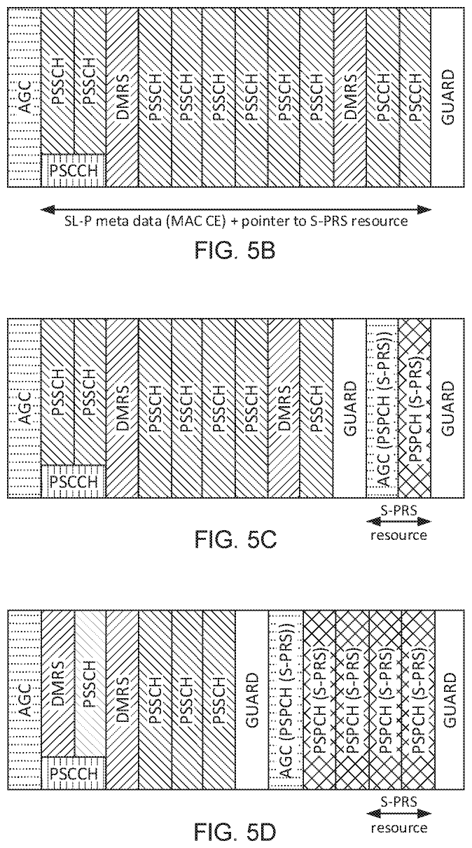

FIG. 5A illustrates positioning metadata contained within the PSSCH part of the slot, while the S-PRS transmission is contained within the remaining symbols denoted as PSPCH. FIG. 5B illustrates a slot format, where the cross slot indication of the S-PRS is included in the payload, according to certain embodiments. FIG. 5C illustrates a slot format where a single symbol is reserved for the PSPCH. FIG. 5D illustrates a slot format where multiple symbols are reserved for the PSPCH, according to certain embodiments.

FIG. 5A illustrates an example of a self-contained positioning slot, according to certain embodiments. In this implementation, the positioning metadata can be contained within the PSSCH part of the slot, while the S-PRS transmission can be contained within the remaining symbols denoted as PSPCH. The indication of this special slot format can be provided directly in the SCI, as is described further below.

In the implementation of FIG. 5A, the transmitter of the metadata and S-PRS can be the same.

FIG. 5B illustrates an example of a cross slot positioning indication, according to certain embodiments. In this implementation, the positioning metadata can be sent in a first slot within the PSCCH/PSSCH, which includes a pointer to one or more subsequent slot, or even sub-channels within the same slot, where the S-PRS will be transmitted.

In the example provided in FIG. 5B, the S-PRS can then be transmitted in symbol(s) within a physical sidelink positioning channel. The transmission of the S-PRS on the resources indicated by the pointer can be accomplished by the UE transmitting the first slot or the transmission of the S-PRS can be accomplished by one of the intended receivers of the transmission in the first slot. Both implementations can coexist in the same resource pool.

In the implementation of FIG. 5B, the transmitter of the metadata and S-PRS are not necessarily the same, as described above. The PSPCH symbols can also coincide in time with the PSFCH symbol, but utilizing the frequency resources/sub-channels not allocated for PSFCH; or in an alternative the PSPCH can have the PSPCH's own symbols reserved in another slot, as per resource pool configuration.

FIGS. 5A through 5D illustrate examples of integration of the S-PRS into a backward/forward compatible SL slot structure, according to certain embodiments. FIG. 5A illustrates a self-contained SL slot with positioning metadata and S-PRS; FIG. 5B illustrates cross slot indication of the S-PRS transmission opportunity. In FIG. 5C a single symbol is reserved for the PSPCH, while in FIG. 5D multiple symbols are reserved for the PSPCH.

In one embodiment, the positioning metadata may include pointers to multiple S-PRS transmission opportunities or resources in a current slot (for example, a self-contained positioning slot) and/or subsequent slots, for example a cross slot positioning indication. This may be particularly beneficial in a scenario where S-PRS is transmitted in a semi-persistent transmission (SPT) manner.

One reason to combine the two implementations may be to indicate multiple S-PRS transmissions both across slots as well as across sub-channels. For example, higher position resolution may be provided if two or more S-PRS transmissions are combined in frequency.

In one embodiment for the case of cross slot positioning indication, the resource(s) where the PSPCH will take place may have to be preceded by an AGC symbol. However, as this AGC symbol can be a repetition of the PSPCH payload (for example, the S-PRS) then if the receiving UE's AGC is fast enough, then the UE can in principle still use this additional S-PRS for positioning/ranging purposes.

Certain embodiments have various aspects. For example, certain embodiments relate to a self-contained positioning slot format and/or a cross slot positioning indication slot format. Moreover, certain embodiments relate to associated signaling detail, such as SCI and resource pool configuration aspects. Furthermore, certain embodiments relate to application of the proposed positioning slot formats to achieve positioning and/or ranging.

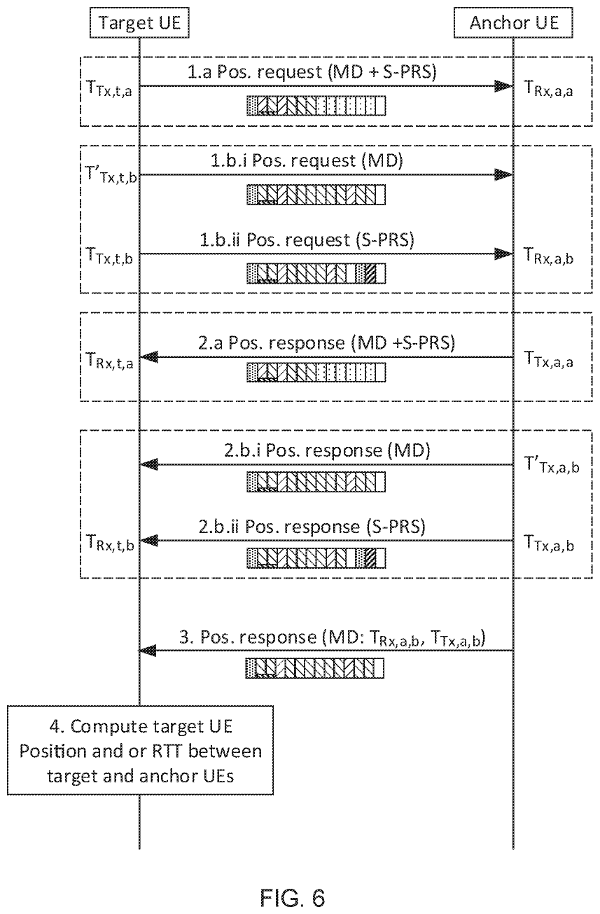

FIG. 6 illustrates examples of use cases of the slot format for 2-step positioning or round trip time, according to certain embodiments. FIG. 6 and the associated discussion illustrate examples of positioning/ranging use case where the proposed slot structure is used. The signaling associated with this use case is depicted in the example of FIG. 6. The difference between acquiring positioning or ranging may depend on the positioning metadata content exchanged in the signaling procedure described below.

As shown in FIG. 6, to either acquire positioning or ranging, the target UE can transmit a positioning/ranging request towards the Anchor UE. For example, at 1.a, when applying the self-contained slot format, the target UE can transmit at TTx,t,a, a positioning/ranging request that includes a Meta-Data (MD) payload that includes the indication that the target UE requires support to acquire the target UE's position or ranging towards the anchor UE. The presence of the S-PRS in the associated PSPCH can aid the anchor UE in determining the time instant TRx,a,a.

When applying the cross slot positioning indication slot format, shown as 1.b.i, at time T′Tx,t,b, the target UE can transmit a positioning/ranging request that includes an MD payload that includes the indication that the target UE requires support to acquire the target UE's position or ranging towards the anchor UE. This request also includes a pointer to which time and frequency resource will be used to transmit the S-PRS.

At T′Tx,t,b using message 1.b.ii, the target UE can perform the transmission of the S-PRS in the resources indicated in 1.b.i. The presence of the S-PRS can aid the anchor UE in determining the time instant TRx,a,b.

In both slot formats, the MD can also include the position of the target UE (when available), as this may allow the anchor UE, when aware of the anchor UE's own position, to acquire in one step the ranging information towards the Target UE.

The anchor UE upon receiving the positioning/ranging request from the target UE, can store the TRx,a,b associated with the reception of the S-PRS and prepare the positioning/ranging response towards the target UE. As shown at 2.a, when applying the self-contained slot format, the anchor UE can transmit at TTx,a,a a positioning/ranging response composed by an MD payload and the S-PRS that is to be used by the target UE to compute the TRx,t,a. In case of positioning, the content of the MD can be the TRx,a,a and TTx,a,a (or the difference between TRx,a,a and TTx,a,a, which can be used in the RTT computation at the target UE) as well as the anchor UE own position. In the case of ranging, the content of the MD can be limited to TRx,a,a and TTx,a,a.

When applying the cross slot positioning indication slot format, at T′Tx,a,b, the anchor UE can transmit with message 2.b.i a positioning/ranging response that includes an MD payload that includes the required information to perform positioning/ranging as well as a pointer to which time and frequency resource will be used to transmit the S-PRS. In case of positioning, the content of the MD can be the TRx,a,b and TTx,a,b (which can be used in the RTT computation at the target UE) as well as the anchor UE own position. In the case of ranging, the content of the MD can be limited to TRx,a,b and TTx,a,b.

Using message 2.b.ii, at TTx,a,b, the anchor UE can transmit the S-PRS in the resources indicated in 2.b.i. The presence of the S-PRS can aid the anchor UE in determining the time instant TRx,t,b.

At 3, an additional MD payload can be transmitted by the Anchor UE after the S-PRS has been transmitted. In this option, the MD payload can include the TRx,a,b and TTx,a,b (which may be used in the RTT computation at the target UE) as well as the anchor UE own position. The triggering of this additional payload can be due to the initial reply from the anchor UE (for example, message 2.a or message 2.b) not including this metadata. Another trigger may be that the payload included in the first transmitted MD may need to be updated.

The reasons for the MD needing update may include that the TRx,a,b and TTx,a,b (or the difference between TRx,a,b and TTx,a,b) that was initially transmitted may not be correct due to the planned S-PRS transmission time TTx,a,b being different from the actual S-PRS transmission above a tolerated error margin. The error margin can be obtained from the positioning accuracy requirements.

The reasons for the MD needing update may also include that the TRx,a,b and TTx,a,b (or the difference between TRx,a,b and TTx,a,b) initially transmitted was not correct due to the anchor UE being unable to transmit the S-PRS in the indicated resources. For example, this inability may be due to prioritization of the transmission of another signal during the time where the S-PRS should be transmitted. In this case, the contents of this message may be the same as message 2, since the S-PRS may have to be transmitted again and therefore all the information sent in message 2 may be needed.

The updated MD may not be needed, as there may be no reason to provide updated MD.

At 4, the target UE can then compute the RTT, which can be applied directly to obtain the ranging. In case of positioning, the target UE can use the computed RTT towards the anchor together with the obtained position from the anchor UE to compute the target UE's own position. For this later step to occur, the target UE may need to also have the RTT and position of at least two other non-co-linear anchor UEs. As another option, the target UE may need to be or become aware of the direction of arrival (DoA) when receiving the anchor UE's positioning response.

There may be various signaling and configuration aspects of certain embodiments. For example, there may be a self-contained positioning slot. In this slot format the SCI (1st stage and 2nd stage) may need to reflect various considerations. For a first stage SCI, the symbols used for the PSSCH transmission, where the positioning metadata will be included may need to be considered. For the second stage SCI, the symbols used for the S-PRS transmission, for example the PSPCH symbols, may need to be considered. Likewise, for the second stage SCI, S-PRS generation parameters used may need to be considered, in order for the receiver to be able to detect the S-PRS without having to perform blind detection. In a first stage SCI, the number of sub-channels used by this slot, which may be dependent on the accuracy required for positioning ranging, may need to be considered. For example, the higher the accuracy, the higher the number of sub-channels that may be needed.

Similarly, there may need to be considerations for a cross-slot positioning indication. In this slot format, the SCI (first stage or second stage) of the first transmitted slot may need to reflect various considerations. For first stage SCI, the symbols used for the PSSCH transmission, where the positioning metadata will be included may need to be considered. For second stage SCI, the mapping to the time and frequency resources in a future SL slot where the S-PRS will be transmitted, for example the PSPCH symbols, may need to be considered. Also to be considered for second stage SCI may be the S-PRS generation parameters used, in order for the receiver to be able to detect the S-PRS without having to perform blind detection. Additionally, for second stage SCI, there may need to be an indication of whether the indicated S-PRS resource is going to be used by the transmitting UE, the UE transmitting this first slot, or if the indicated resources are for the use of the intended receivers of this transmission, such as for those intended receivers to transmit their S-PRS.

The second stage SCI format and S-PRS mapping rule may have further considerations. For example, the first stage SCI fields may be compatible with the 1st stage SCI format 1A already specified. However, the mapping to the resources of when the S-PRS transmission will take place may require the introduction of a second stage SCI format that can enable the physical layer details associated with the S-PRS transmissions. These details may include in which symbols the S-PRS transmission will take place (including repetitions, in which slot the S-PRS transmission will take place, and how many sub-channels the S-PRS will require, as well as in which sub-channels, such as the starting and ending sub-channels.

An alternative to providing the symbols and slots for S-PRS transmission in the second stage SCI may be to define a mapping rule in the specifications. Where similar to the PSCCH/PSSCH to PSFCH mapping, there may be a mapping between PSCCH/PSSCH and the PSPCH. In this case, there may be a parameter defined either in the second stage SCI or in the resource pool configuration regarding the S-PRS bandwidth. The later approach may simplify the PSPCH resource allocation, but may fix the S-PRS bandwidth to an equivalent maximum positioning accuracy. The former approach may have the benefit of allowing the target/anchor UE to adjust the required S-PRS bandwidth to meet the accuracy requirements. However, a mix of the two approaches may also be considered, where the resource pool configuration may provide the maximum S-PRS bandwidth, while the 2nd stage SCI S-PRS bandwidth may indicate the actual S-PRS bandwidth used, which may be smaller than the maximum S-PRS bandwidth.

Additionally, the S-PRS generation parameters (for example, root sequence and cyclic shift) can either be provided dynamically as part of a 2nd stage SCI parameter or can be defined by the resource pool configuration. In the latter case, multiple S-PRS generation parameters can be indicated in the resource pool configuration and then the UE can indicate which S-PRS configuration is being used via an index indicated in the second stage SCI.

Also, the indication in which SL slots a PSPCH can occur can be part of the resource pool configuration. Moreover, the resource pool configuration can be provided by the network, when the UE is in coverage, or can be part of the UE pre-configuration when the UE is out-of-coverage.

Certain embodiments may also relate to S-PRS transmission time calculation aspects.

A user equipment device may not be aware of the exact S-PRS transmission time due changes in the DL synchronization and other radio frequency (RF) delays that the TX chain introduces. However, the device may also not be capable of measuring these additional delays after it has sent the RTT reply (for example, message 2 in FIG. 6). To be aware, the device could be equipped with a feedback receiver, that could capture the signal right at the moment it is sent by the Tx antenna. This receiver would itself inadvertently introduce processing delays, which would add additional errors to the Tx time estimation, since the receiver wouldn't be able to correctly estimate the TX drifts, as it wouldn't be able to decouple the TX errors from the receiver's own RX processing errors. This unfortunately is a problem in positioning, and to solve it, or to make the network aware of its severity, additional signaling in the form of timing error group (TEG) can provide a measure that tells the network what is the maximum error range that the UE errors introduce in the positioning measurements. To conclude, the limitation regarding the imprecise TX time may be there regardless of when the report is sent, where the report is sent together with the SRS signal, or whether the report is sent right after the SRS signal.

Another workaround for this issue could be that when a UE reference clock adjustment is happening in-between building and actually transmitting, there can be an RX-TX time report message. In this case the UE can estimate the impact but can indicate that the difference is not included in the RTT report if sent together with the reply S-PRS. This can be avoided by preventing reference clock updates while the RTT session is running. Disabling any update of frequency and time for this short period may not harm the UE's other activities and may improve the RTT reporting accuracy.

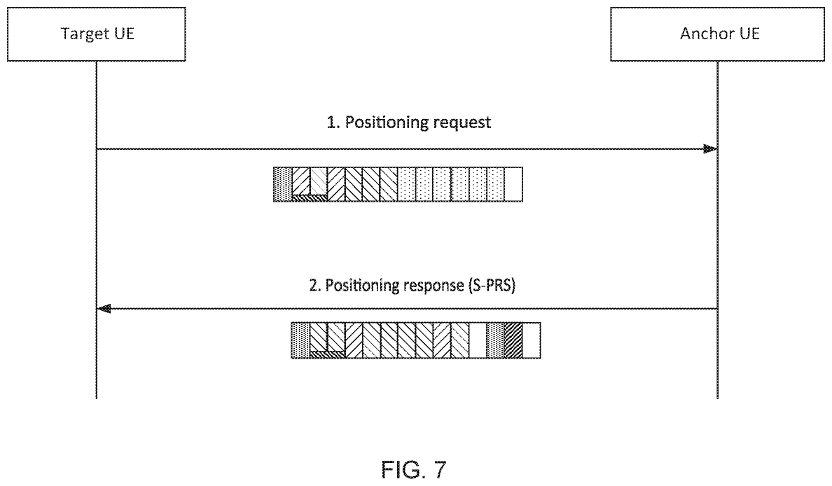

FIG. 7 illustrates an example of an alternative application of the cross slot positioning indication, according to certain embodiments. In FIG. 7, the positioning request, besides including the meta data from the target UE and the S-PRS, can indicate the resource (for example, the PSFCH slot) where the S-PRS is to be transmitted by the anchor UE. This indication can be provided as a pointer to the time and frequency resource where the anchor UE should reply with an S-PRS.

FIG. 8 illustrates an example flow diagram of a method for providing sidelink slots and suitable configuration thereof for sidelink positioning reference signal transmission and reception, according to certain embodiments.

The method can include, at 810, sending, from a target user equipment to an anchor user equipment, a sidelink positioning request in a channel. The channel can be a physical sidelink positioning channel. The sidelink positioning request can include a first payload. The first payload can include a first sidelink positioning reference signal. FIGS. 6 and 7 provide examples of positioning requests.

The first payload can include positioning metadata. The positioning metadata can include pointers to multiple transmission opportunities for sidelink positioning reference signal transmission by the anchor user equipment, to a transmission occasion for the apparatus, or both. The sidelink positioning request can include positioning metadata in a same slot with the first sidelink positioning reference signal.

The sidelink positioning request can include positioning metadata in a first slot that includes a pointer to the first sidelink positioning reference signal in a second slot, or a symbol outside the first slot, or a sub-channel of the first slot.

As shown in FIG. 8, the method can also include receiving, at 820, from the anchor user equipment, a sidelink positioning response. The sidelink positioning response can be sent according to the payload of the sidelink positioning request. The sidelink positioning response can include a second payload. FIGS. 6 and 7 provide examples of positioning responses.

The sidelink positioning response can include a second sidelink positioning reference signal and the transmission of the first sidelink positioning reference signal and the second sidelink positioning reference signal can coexist with non-positioning-related sidelink transmissions in a same resource pool as the non-positioning-related sidelink transmissions.

The second payload can include positioning metadata. The positioning metadata can include a known position of a device transmitting the sidelink positioning reference signal, a reception-transmission time for round trip time determination, or both.

As shown in FIG. 8, the method can further include, at 830, determining a position of the target user equipment based on the second payload. The determined position can be used for tracking, guidance, and many other purposes. For example, the determined position can be logged, reported to another device, or displayed to a user of the target user equipment.

The method can additionally include, at 825, receiving, from the anchor user equipment, an update to the sidelink positioning response. The update can be configured to modify second payload prior to the determination of the position. Various triggers for such an update are discussed above.

It is noted that FIG. 8 is provided as one example embodiment of a method or process. However, certain embodiments are not limited to this example, and further examples are possible as discussed elsewhere herein.

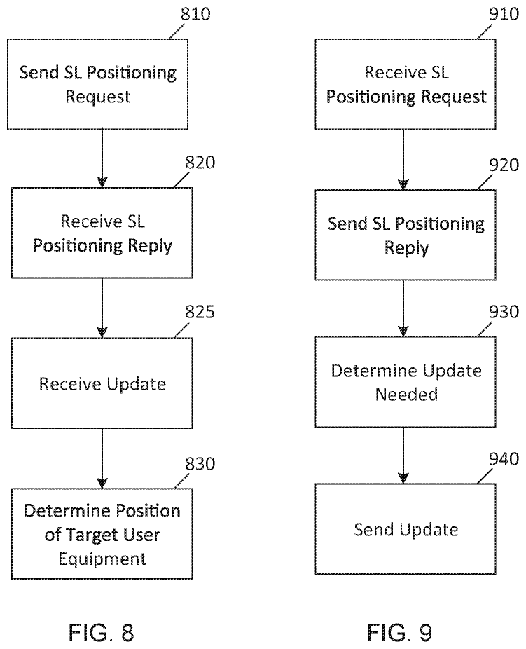

FIG. 9 illustrates an example flow diagram of a method for providing sidelink slots and suitable configuration thereof for sidelink positioning reference signal transmission and reception, according to certain embodiments. The method of FIG. 9 can be used alone or in combination with the method of FIG. 8.

The method can include, at 910, receiving, from a target user equipment, a sidelink positioning request on a channel. The channel can include a physical sidelink positioning channel. This can be the same sidelink positioning request sent at 810 in FIG. 8.

The sidelink positioning request can include positioning metadata in a same slot with the first sidelink positioning reference signal. As another option, the sidelink positioning request can include positioning metadata in a first slot comprising a pointer to the first sidelink positioning reference signal in a second slot, or a symbol outside the first slot, or a sub-channel of the first slot.

The first payload can include positioning metadata. The positioning metadata can include pointers to multiple transmission opportunities for sidelink positioning reference signal transmission by the anchor user equipment, to a transmission occasion for the apparatus, or both.

As shown in FIG. 9, the method can further include, at 920, sending, to the target user equipment, a sidelink positioning response. The sidelink positioning response can be sent according to the payload of the sidelink positioning request. The sidelink positioning response can be the same sidelink positioning response received at 820 in FIG. 8.

The sidelink positioning response can include a second payload. The second payload can be configured to enable the target user equipment to determine a position of the target user equipment.

The sidelink positioning response can include a second sidelink positioning reference signal and the transmission of the first sidelink positioning reference signal and the second sidelink positioning reference signal can coexist with non-positioning-related sidelink transmissions in a same resource pool as the non-positioning-related sidelink transmissions.

The second payload can include positioning metadata. The positioning metadata can include a known position of a device transmitting at least one of the sidelink positioning reference signal, or a reception-transmission time for round trip time determination.

At 930, the method can include determining that an update to the sidelink positioning response is needed. The method can also include, at 940, sending, to the target user equipment, an update to the sidelink positioning response. The update can be configured to modify second payload prior to determination of a position of the target user equipment.

It is noted that FIG. 9 is provided as one example embodiment of a method or process. However, certain embodiments are not limited to this example, and further examples are possible as discussed elsewhere herein.

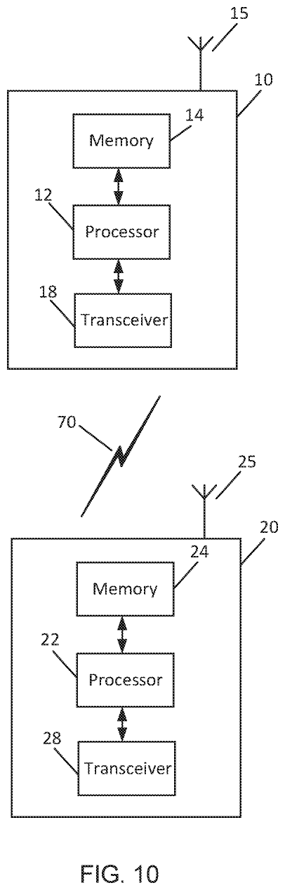

FIG. 10 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 10.

As illustrated in the example of FIG. 10, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 10, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIG. 1-9, or any other method described herein. In some embodiments, as discussed herein, apparatus 10 may be configured to perform a procedure relating to providing sidelink slots and suitable configuration thereof for sidelink positioning reference signal transmission and reception, for example.

FIG. 10 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 10.

As illustrated in the example of FIG. 10, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 10, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIG. 1-9, or any other method described herein. For example, in an embodiment, apparatus 20 may be controlled to perform a process relating to providing sidelink slots and suitable configuration thereof for sidelink positioning reference signal transmission and reception, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may enable the sidelink positioning exchanges to take place in resource pools utilized by other non-positioning sidelink devices. Such exchanges taking place in resource pools utilized by other non-positioning sidelink devices may optimize spectral efficiency. In addition, certain embodiments may ensure backwards compatibility with the existing SL slot design.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### Partial Glossary

S-PRS Sidelink Positioning Reference Signals
PSCCH Physical Sidelink Control Channel
PSSCH Physical Sidelink Shared Channel
PSFCH Physical Sidelink Feedback Channel
PSPCH Physical Sidelink Positioning Channel
MD Meta Data
SCI Sidelink Control Information
RTT Round Trip Time
CAZAC constant amplitude zero autocorrelation
DMRS demodulated reference symbols
SPT Semi persistent Transmission
TEG Timing Error Group

1. An apparatus, comprising:
at least one processor; and
at least one memory comprising computer program instructions,
wherein the at least one memory and the computer program instructions are configured to, with the at least one processor, cause the apparatus at least to perform:
sending, to an anchor user equipment, a sidelink positioning request in a channel, wherein the sidelink positioning request comprises a first payload;
receiving, from the anchor user equipment, a sidelink positioning response, wherein the sidelink positioning response is sent according to the payload of the sidelink positioning request, wherein the sidelink positioning response comprises a second payload; and
determining a position of the apparatus based on the second payload.

2. The apparatus of claim 1, wherein the channel comprises a physical sidelink positioning channel.

3. The apparatus of claim 1, wherein the first payload comprises a first sidelink positioning reference signal.

4-7. (canceled)

8. The apparatus of claim 1, wherein the first payload comprises positioning metadata.

9. The apparatus of claim 8, wherein the positioning metadata comprises pointers to multiple transmission opportunities for sidelink positioning reference signal transmission by the anchor user equipment, to a transmission occasion for the apparatus, or both.

10. The apparatus of claim 3, wherein the sidelink positioning request comprises positioning metadata in a same slot with the first sidelink positioning reference signal.

11. The apparatus of claim 3, wherein the sidelink positioning request comprises positioning metadata in a first slot comprising a pointer to the first sidelink positioning reference signal in a second slot, or a symbol outside the first slot, or a sub-channel of the first slot.

12. The apparatus of claim 1, wherein the at least one memory and the computer program instructions are configured to, with the at least one processor, cause the apparatus at least to perform:
receiving, from the anchor user equipment, an update to the sidelink positioning response, wherein the update is configured to modify second payload prior to the determination of the position.

13. An apparatus, comprising:
at least one processor; and
at least one memory comprising computer program instructions,
wherein the at least one memory and the computer program instructions are configured to, with the at least one processor, cause the apparatus at least to perform:
receiving, from a target user equipment, a sidelink positioning request on a channel, wherein the sidelink positioning request comprises a first payload; and
sending, to the target user equipment, a sidelink positioning response, wherein the sidelink positioning response is sent according to the payload of the sidelink positioning request,
wherein the sidelink positioning response comprises a second payload, wherein the second payload is configured to enable the target user equipment to determine a position of the target user equipment.

14. The apparatus of claim 13, wherein the channel comprises a physical sidelink positioning channel.

15. The apparatus of claim 13, wherein the first payload comprises a first sidelink positioning reference signal.

16. The apparatus of claim 15, wherein the sidelink positioning response comprises a second sidelink positioning reference signal.

17. The apparatus of claim 16, wherein the transmission of the first sidelink positioning reference signal and the second sidelink positioning reference signal coexist with non-positioning-related sidelink transmissions in a same resource pool as the non-positioning-related sidelink transmissions.

18. The apparatus of claim 13, wherein the second payload comprises positioning metadata.

19. The apparatus of claim 18, wherein the positioning metadata comprises at least one of a known position of a device transmitting the sidelink positioning reference signal, or a reception-transmission time for round trip time determination.

20. The apparatus of claim 13, wherein the first payload comprises positioning metadata.

21. The apparatus of claim 20, wherein the positioning metadata comprises pointers to multiple transmission opportunities for sidelink positioning reference signal transmission by the anchor user equipment, to a transmission occasion for the apparatus, or both.

22-23. (canceled)

24. The apparatus of claim 13, wherein the at least one memory and the computer program instructions are configured to, with the at least one processor, cause the apparatus at least to perform:
determining that an update to the sidelink positioning response is needed; and
sending, to the target user equipment, an update to the sidelink positioning response, wherein the update is configured to modify second payload prior to determination of a position of the target user equipment.

25. A method, comprising:
sending, from a target user equipment to an anchor user equipment, a sidelink positioning request in a channel, wherein the sidelink positioning request comprises a first payload;
receiving, from the anchor user equipment, a sidelink positioning response, wherein the sidelink positioning response is sent according to the payload of the sidelink positioning request, wherein the sidelink positioning response comprises a second payload; and
determining a position of the target user equipment based on the second payload.

26-36. (canceled)

37. A method, comprising:
receiving, from a target user equipment, a sidelink positioning request on a channel, wherein the sidelink positioning request comprises a first payload; and
sending, to the target user equipment, a sidelink positioning response, wherein the sidelink positioning response is sent according to the payload of the sidelink positioning request,
wherein the sidelink positioning response comprises a second payload, wherein the second payload is configured to enable the target user equipment to determine a position of the target user equipment.

38-72. (canceled)
